(19) United States
(12) Patent Application Publication
(10) Pub. No.: US 2014/0211466 A1
(43) Pub. Date: Jul. 31, 2014

(54) ÉTENDUE SHAPING USING FACETED ARRAYS

(71) Applicants: Paul Gerard Dewa, Newark, NY (US); Paul Francis Michaloski, Rochester, NY (US)

(72) Inventors: Paul Gerard Dewa, Newark, NY (US); Paul Francis Michaloski, Rochester, NY (US)

(21) Appl. No.: 13/754,145

(22) Filed: Jan. 30, 2013

(51) Int. Cl. F21V 7/00

(52) U.S. Cl. CPC F21V 7/0083
USPC 362/235

(57) ABSTRACT

An apparatus for directing laser light has an illumination source having one or more lasers that are each energizable to emit laser light. A first faceted array in the path of the emitted laser light from the illumination source has at least a first light-redirecting facet and an adjacent second light-redirecting facet. A second faceted array, spaced apart from the first faceted array by a light propagation distance has at least a first light-collimating facet and a second light-collimating facet, wherein the first and second collimating facets define an output axis and wherein the emitted light that is redirected from the first light-redirecting facet is incident to the first light-collimating facet and directed along the output axis and wherein the emitted light that is redirected from the second light-redirecting facet is incident to the second light-collimating facet and directed along the output axis.

### FIELD OF THE INVENTION

This invention generally relates to optical apparatus that generate laser light and more particularly relates to apparatus and methods for conditioning the etendue of light emitted from solid-state laser sources.

### BACKGROUND

There are a number of applications for which it is advantageous to combine laser light from multiple laser sources or to redistribute the spatial arrangement of the emitted laser light in order to provide a more efficient light source for an optical system that has a symmetrical input aperture. These applications include those using any of a number of types of laser sources, including excimer lasers and solid-state lasers, for example.

Laser diodes are solid-state emissive devices employed in a broad range of applications where highly coherent light is useful. While laser diodes offer a number of advantages for size, cost, and performance, however, these devices do not provide an output beam that is well-suited for use with systems that handle rotationally symmetric light, such as optical apparatus that use conventional spherical optics. The output beam of the laser diode, when considered in cross-section, has an aspect ratio that is highly asymmetric, with markedly different divergence angles in respectively orthogonal directions. The output beam emits from a wide stripe which extends along a “slow” axis to a width dimension that is several times its height along a “fast” axis that is orthogonal to the slow axis. Rotationally symmetric optics, meanwhile, are optimized for handling light beams that are themselves substantially symmetric. Thus, adapting the light from a laser diode or laser diode array to a spherical optical system can require components and techniques for rearranging the distribution of the light, such as by stacking beams of multiple lasers along the fast width, for example, to form a composite beam that has a more symmetric aspect ratio.

The innate asymmetry of the laser diode light is particularly disadvantageous for use with optical fibers. The highly symmetric input aperture of the optical fiber is poorly matched to the aspect ratio of the laser diode output beam, making it difficult to design an efficient optical system that can use all of the light output. In effect, when using light from a single laser diode, the input aperture of the optical fiber is readily over-filled in one direction and under-filled in the orthogonal direction.

One result of this innate incompatibility between the laser diode and optical fibers is that it imposes constraints on laser diode design. Laser diodes that are used to provide pump excitation light for fiber lasers, for example, are constrained in emitting stripe width, with an emitter width that is nominally no more than about 100 μm. Emitters having a wider stripe width, such as diodes with an emitter stripe width of 120 μm or longer, have been described and would be more efficient and provide proportionately more light. However, due to output beam geometry, the emitted energy in the slow axis direction would well exceed the input NA of the optical fiber in one direction (slow axis), while still under-filling the aperture in the orthogonal (fast axis) direction.

More generally, the problem of poor etendue matching often constrains the potential efficiency of optical apparatus that use laser diodes and other types of lasers, as well as light-emitting diodes (LEDs) and other types of solid-state light sources. This problem can lead to over-filling or under-filling the input aperture of an optical system, often making system designs using lasers less efficient.

Thus, it can be appreciated that there is a need for a solution that rearranges the light output of a solid-state laser diode or other laser source so that it is more compatible with symmetric optics and is better suited for efficient use with optical fibers and with other conventional optical systems.

### SUMMARY

It is an object of the present invention to advance the art of laser beam light handling and application. With this object in mind, the present disclosure provides an apparatus for directing laser light comprising:
a) an illumination source having one or more lasers that are each energizable to emit laser light;
b) a first faceted array in the path of the emitted laser light from the illumination source, the first faceted array having at least a first light-redirecting facet and an adjacent second light-redirecting facet;
and
c) a second faceted array, spaced apart from the first faceted array by a light propagation distance and having at least a first light-collimating facet and a second light-collimating facet, wherein the first and second collimating facets define an output axis and wherein the emitted light that is redirected from the first light-redirecting facet is incident to the first light-collimating facet and directed along the output axis and wherein the emitted light that is redirected from the second light-redirecting facet is incident to the second light-collimating facet and directed along the output axis.

An advantage provided by the present invention is the capability to re-shape the etendue for an individual light beam generated from one or more laser or solid-state light sources. This enables improvements for using light from one or more lasers more efficiently. This can also offer advantages for easier alignment of laser diode beams, such as those used to provide light for pumped lasers.

Other desirable objectives, features, and advantages of the disclosed invention may occur or become apparent to those skilled in the art. The invention is defined by the appended claims.

### BRIEF DESCRIPTION OF THE DRAWINGS

FIG. 1A is a schematic diagram that shows the asymmetry of the laser diode output beam.

FIG. 1B is a plan view schematic diagram showing spatial and angular distribution for a light source with a given aspect ratio of etendue.

FIG. 1C is a plan view schematic diagram showing changes to spatial and angular distribution for a light source with magnification along one axis.

FIG. 2 is a schematic block diagram that shows a light combining apparatus according to an embodiment of the present invention.

FIG. 3 is a schematic block diagram that shows light-combining components for one solid state light source in the light combining apparatus.

FIG. 4 is a schematic top view of the apparatus of FIG. 2 showing spatial and angular distributions for laser diode light at different positions in the light combining apparatus.

FIG. 5A is a schematic plan view showing a mapping of light-redirecting elements from a first faceted array to a second faceted array.

FIG. 5B shows light redistribution by the first and second faceted arrays of FIG. 5A.

FIG. 6A is a schematic side view showing the operation of prism facets as light combining apparatus components.

FIG. 6B is a schematic side view showing the operation of lens facets as light combining apparatus components.

FIG. 6C is a schematic side view showing the operation of reflective facets as light combining apparatus components.

FIG. 6D is a schematic side view showing the operation of off-axis reflective parabolic segment facets as light combining apparatus components.

FIG. 6E is a schematic side view showing the operation of ellipsoid reflective facets as light combining apparatus components.

FIG. 7A is a schematic top view showing a light combining apparatus with two arrays of curved reflectors and tracing a portion of the optical path from the laser sources to the first array according to an alternate embodiment of the present invention.

FIG. 7B is another schematic top view showing the light combining apparatus of FIG. 7A and tracing another portion of the optical path between the arrays.

FIG. 7C is another schematic top view showing the light combining apparatus of FIGS. 7A and 7B and tracing the portion of the optical path beyond the second array of curved reflectors.

FIG. 7D is a schematic side view showing one channel of the light combining apparatus of FIG. 7A and tracing the path of light from the source to the pair of arrays and to an optical fiber.

FIG. 7E is a perspective view showing the channel of the light combining apparatus of FIG. 7D.

FIG. 7F is a plan view that shows the spatial distribution of laser light at each of the reflective elements that are the reflective facets in the light combining apparatus of FIGS. 7A-7E.

FIG. 8 is a schematic top view that shows an optical apparatus for combining light from multiple laser diodes using polarization.

### DETAILED DESCRIPTION

Figures shown and described herein are provided in order to illustrate key principles of operation and fabrication for an optical apparatus according to various embodiments and a number of these figures are not drawn with intent to show actual size or scale. Some exaggeration may be necessary in order to emphasize basic structural relationships or principles of operation.

The figures provided do not show various supporting components, including optical mounts, power sources and circuit board mounting for laser diodes, and other features. It can be appreciated by those skilled in the optical arts that embodiments of the present invention can use any of a number of types of standard mounts and support components.

In the context of the present disclosure, terms such as “top” and “bottom” or “above” and “below” or “beneath” are relative and do not indicate any necessary orientation of a component or surface, but are used simply to refer to and distinguish views, opposite surfaces, spatial relationships, or different light paths within a component or block of material. Similarly, terms “horizontal” and “vertical” may be used relative to the figures, to describe the relative orthogonal relationship of components or light in different planes, for example, but do not indicate any required orientation of components with respect to true horizontal and vertical orientation.

Where they are used, the terms “first”, “second”, “third”, and so on, do not necessarily denote any ordinal or priority relation, but are used for more clearly distinguishing one element or time interval from another. These descriptors are used to clearly distinguish one element from another similar element in the context of the present disclosure.

As used herein, the term “energizable” relates to a device or set of components that perform an indicated function upon receiving power and, optionally, upon receiving an enabling signal. For example, a laser diode is energizable to emit a beam of laser light.

In the context of the present disclosure, two planes, direction vectors, or other geometric features are considered to be substantially orthogonal when their actual or projected angle of intersection is within +/−2 degrees of 90 degrees.

The beam aspect ratio is considered as it would be generally understood to those skilled in the optical arts, that is, considered orthogonally relative to the central axis of the light beam or cross-sectionally in the plane perpendicular to the propagation direction.

In the context of the present invention, a surface considered to “reflect” or to be reflective at a certain wavelength reflects at least about 95% of incident light of that wavelength. A surface considered to “transmit” or to be transmissive at a certain wavelength transmits at least about 80% of incident light of that wavelength.

In the context of the present invention, the term “oblique” or phrase “oblique angle” is used to mean a non-normal angle that is slanted so that it differs from normal, that is, differs from 90 degrees or from an integer multiple of 90 degrees, by at least about 2 degrees or more along at least one axis. For example, an oblique angle may be at least about 2 degrees greater than or less than 90 degrees using this general definition.

In the context of the present invention, a “composite beam” is formed from a set of two or more individual “component beams”. Two light paths are considered to be “optically parallel” when they travel in the same direction within the same refractive component or medium, so that corresponding segments of two optically parallel light paths, when both path segments extend within the same refractive medium, are geometrically parallel to each other. Paths that are optically parallel can also be considered to be piece-wise parallel for corresponding segments that are within the same transparent medium.

The shape and composition of an optical component define an optical axis. These characteristics, plus aspects of placement and position of two or more optical components that direct light in parallel or that focus the light are considered to define an output axis for the directed or focused light.

In the context of the present invention, two adjacent optical elements are considered to be “substantially coplanar” if there is intersection between both elements and a plane that is substantially orthogonal to the axis of emitted light that is directed to either of the two optical elements. Under this definition, some curvature is allowed, provided that a plane having this geometrical relationship to the axis can intersect both elements.

In the context of the present invention, the term “illumination” is used as a general term to describe a grouping of one or more components or apparatus that provide light energy, such as laser light, for example.

According to a broad aspect of the present invention, apparatus and methods are provided that enable shaping the etendue of a light beam that is emitted from laser or other light sources, such as by changing its aspect ratio or splitting the light along an edge of a facet element. Advantageously, embodiments of the present invention provide apparatus and methods that can be used for providing laser pump light for a fiber laser or other type of laser as a light beam. Alternate embodiments of the present invention may also serve to condition a light beam in other environments where it is advantageous to be able to adjust the etendue of the light beam. Embodiments of the present invention can be used to shape the etendue of a range of types of light source, including laser diodes and other types of lasers as well as solid-state light sources such as LEDs. For example, excimer lasers also have a relatively asymmetric etendue and may benefit from such shaping for improving efficiency.

In order to better understand what is meant by the phrase “aspect ratio of the etendue”, it is useful to more clearly define etendue and a number of related terms and principles. As is well known in the optical arts, etendue expresses the geometric extent of a light source or of an optical system and relates to the amount of light that is available from a source to an optical system. Etendue cannot decrease in an optical system that is matched to the etendue of its source illumination without the loss of light. Within an optical system, etendue is considered with respect to its spatial distribution and its angular distribution. Etendue can be considered as a geometrical property, a product of two factors: spatial area (A) and solid angle (Ω). In non-imaging optics, etendue can be considered as a volume in phase space.

In an optical system, efficient use of light requires matching the etendue of illumination to the optical components along the light path so that all or predominantly all of the provided light is used. For an optical system that is rotationally symmetric throughout, etendue computation and handling considerations are fairly straightforward. Considered in cross-section, in the plane perpendicular to the propagation direction, the beam is circular with such a system and the optical invariant considered in any direction within the plane is the same. Etendue-matching for components within such an optical system then becomes a problem of simply scaling the spatial and angular extent of the light beam appropriately.

Etendue-matching becomes considerably more complex when the spatial distribution of the light in each axis must be changed in a different way within the optical system. This problem must be addressed, for example, in directing light from a laser diode, with its highly asymmetric etendue characteristics, into an optical fiber that is highly symmetric with respect to etendue.

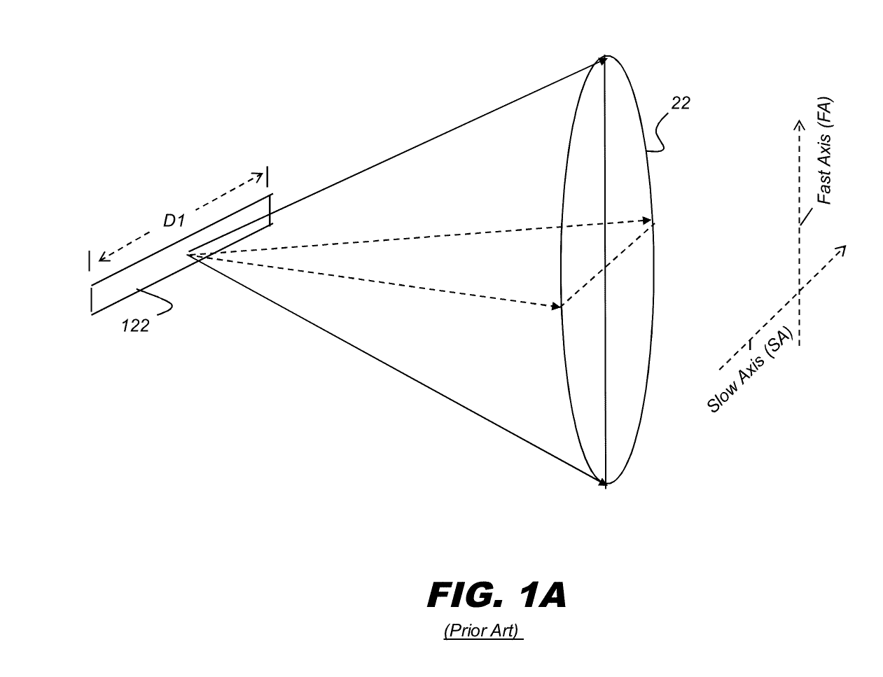

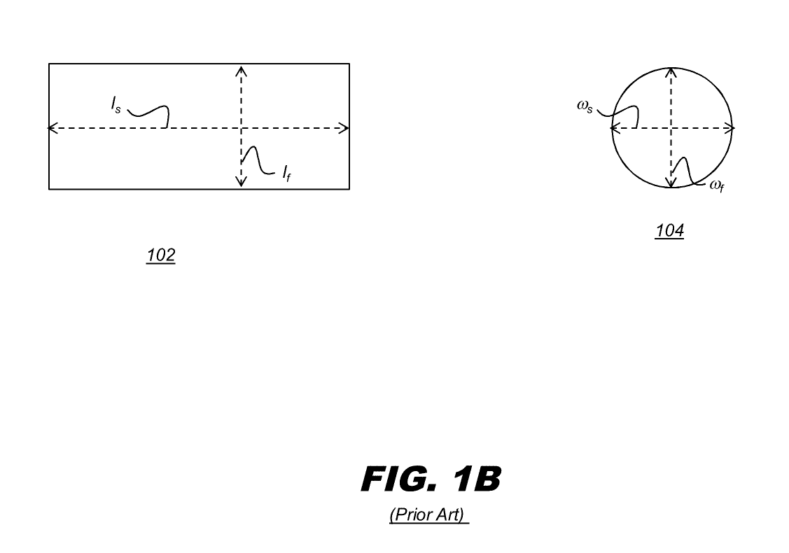

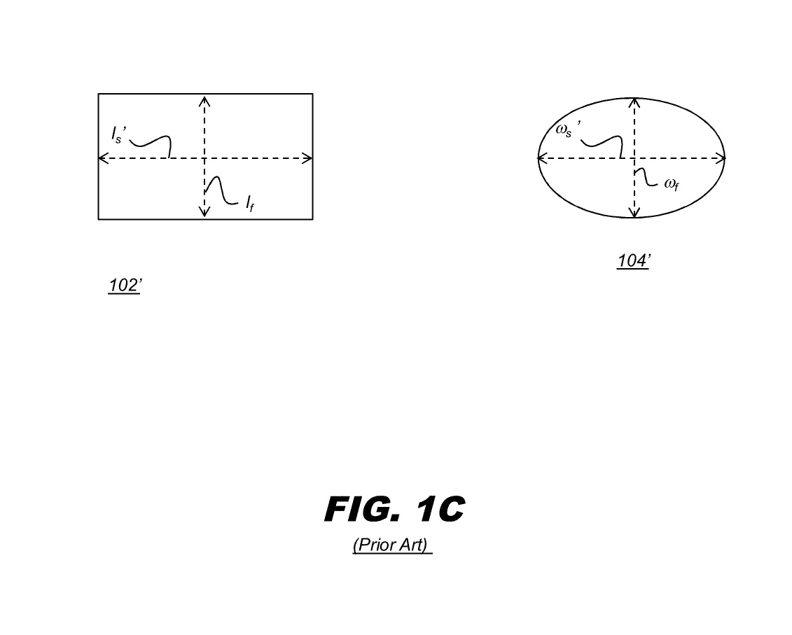

As was noted previously in the background section and represented in FIG. 1A, for laser diodes that are used for laser pump light, the etendue of the solid-state laser diode is markedly asymmetric. FIG. 1A shows, in schematic form, the output from a typical multi-mode laser diode. The laser has a spatial distribution 122, shown as it would appear at the laser output coupler, and an angular distribution 22, shown for the emitted light.

To facilitate description in the context of the present disclosure, the term “optical invariant” is used herein when describing etendue with respect to a single direction or a single dimension. With reference to a representative spatial distribution 102 and corresponding angular distribution 104 of a light beam in FIG. 1B, for example, there is an optical invariant [symbol] in each of the two mutually orthogonal directions shown. With reference to FIG. 1B, there is an optical invariant [symbol] ₛ along a slow axis (SA):

[symbol]

=(lₛ·ωₛ)

wherein (lₛ) is the width dimension of the spatial distribution in the slow axis direction and (ωₛ) is the divergence angle of the light beam, taken in the slow axis direction. There is a different optical invariant [symbol] _{f} along the fast axis (FA):

[symbol]

_{f}=(l_{f}−ω_{f})

wherein (l_{f}) is the height dimension of the spatial distribution in the fast axis direction and (ω_{f}) is the divergence angle taken in that direction.
The total etendue E for this light beam from a given light source can be approximated as the product:

E=( [symbol] ₛ· [symbol] _{f}).

In the context of the present disclosure, the “aspect ratio of the etendue”, denoted R herein, is the quotient:

R=( [symbol] ₛ)/( [symbol] _{f})

Equivalently,

R=(lₛ−ωₛ)/(l_{f}·ω_{f})

It can be noted that, for a light beam that is rotationally symmetric, the aspect ratio of the etendue R=1. Embodiments of the present invention address the difficulties encountered when the aspect ratio of the etendue R is other than 1 for an emitted light beam, and where the aspect ratio of the etendue R is substantially 1 for an optical fiber or other optical component to which the light beam is directed. Examples of illumination having this characteristic include laser diodes. Other laser sources with R other than 1 can have more complex asymmetrical distribution, such as having other than the generally elongated rectangular distribution of the laser diode. Embodiments of the present invention also address the problem of combining light from two or more laser light sources that each have an aspect ratio of etendue R that is more nearly rotationally symmetric. For such applications, the summed etendue of the two or more rotationally symmetric sources is not changed; however, the light can be more efficiently redistributed so that the combined light is more suitable for use in a rotationally symmetric optical system.

It must further be observed that a lens cannot be used to change the aspect ratio of the etendue R. When the light beam is directed through a lens, the aspect ratio of the etendue R remains constant. This applies for spherical lenses (lenses having power in both dimensions) and for cylindrical lenses (lenses having power in only one dimension) as well. FIG. 1C shows, in schematic form, what happens when a cylindrical lens is used to reduce the spatial distribution along dimension (lₛ). The resulting spatial distribution 102′ shows dimension (lₛ′) reduced from that in FIG. 1B; however, the corresponding angular distribution 104′ shows the angular extent increased in a corresponding manner. When a cylindrical lens is used, the aspect ratio of the etendue R is preserved; that is:

R=(lₛ·ωₛ)/(l_{f}·ω_{f})=(lₛ′·ωₛ′)/(l_{f}·ω_{f})

Embodiments of the present invention address the need to change the aspect ratio of the etendue R of an individual beam of light from a light source without loss of light. As one benefit, scaling the aspect ratio of the etendue Rₒᵤₜ of an individual beam of light enables improved adaptation of light sources, such as laser diodes that have a highly asymmetric aspect ratio of the etendue Rₒᵤₜ, to an input, such as an optical fiber that has an aspect ratio of the etendue Rᵢₙ, that is highly symmetrical.

As has been noted, the laser diode characteristically has a significantly larger optical invariant [symbol] ₛ along its longer slow axis (SA) direction, so that its optical invariant along that axis generally comes close to, or even exceeds, that of the optical fiber. The laser diode has a small optical invariant [symbol] _{f} along its narrower fast axis (FA) direction, which is often a single spatial mode. This is characterized by a small spatial dimension, as shown in FIG. 1A as spatial distribution 122, and a large (or fast) angular spread. Emission in the slow axis (SA), on the other hand, with diode width D1, contains a number of spatial modes. SA emission typically has a much larger spatial distribution and a small (slow) angular spread. This light must typically be coupled into an optical fiber or other optical system that works best with rotationally symmetric light. Unlike the laser output shown in FIG. 1A, the etendue of the optical fiber, with a circular aperture of the fiber core and a rotationally symmetric numerical aperture, is symmetric, making it difficult to use light generated from laser diodes efficiently.

By way of example, and not of limitation, typical nominal values for pump laser design include the following:
i. Optical fiber diameter: 105 μm
ii. Optical fiber numerical aperture: 0.15
iii. Optical fiber optical invariant in each axis proportional to: 0.15×0.105 mm*rad=0.01575 mm*rad
iv. Laser source optical invariant [symbol] ₛ (along the slow axis): about 0.015 mm*rad; and
v. Laser source optical invariant [symbol] _{f} (along the fast axis): about 0.0014 mm*rad

Since the optical invariant [symbol] _{f} of the laser in the fast axis is so much smaller than the fiber invariant, there is plenty of room to capture the light along that axis. In the example computations shown above, the slow axis optical invariant [symbol] ₛ exceeds the fast axis optical invariant [symbol] _{f} by more than a factor of 10. The optical invariant [symbol] ₛ of the laser in the slow axis is very close to the invariant of the fiber, making alignment in that direction more difficult.

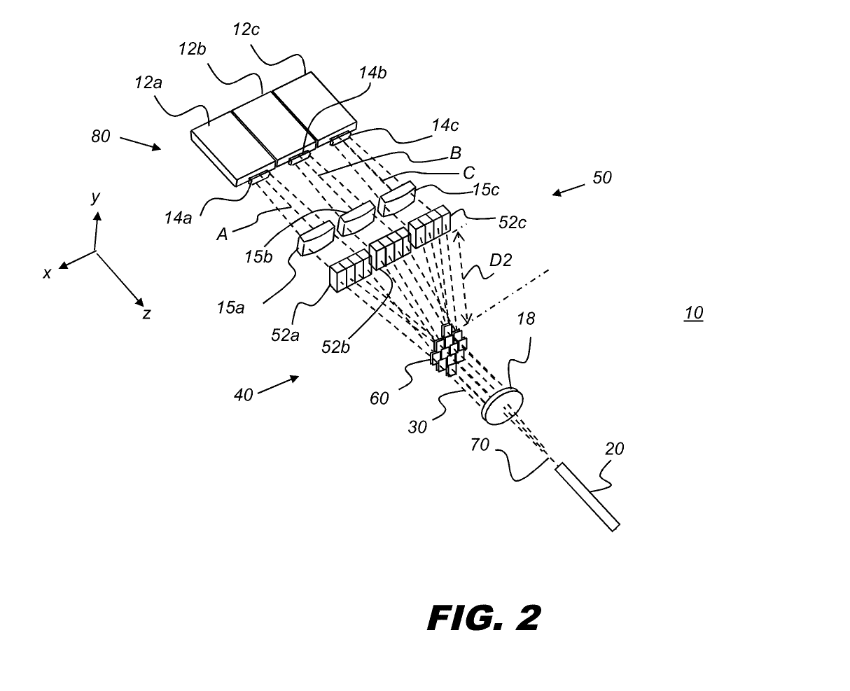

The schematic block diagram of FIG. 2 shows a light combining apparatus 10, such as a laser pump module, for providing a light beam from one or more solid-state lasers 12, or other type of laser or solid-state emitters, of an illumination source 80 to an optical apparatus having a spherically symmetric aperture, shown as an optical fiber 20 in this example. In the embodiment shown, three laser diodes 12a, 12b, and 12c are shown in illumination source 80 by way of example; fewer or more laser diodes or other light sources could be provided. Each laser 12a, 12b, and 12c has a corresponding fast axis (FA) collimator lens 14a, 14b, and 14c and a slow axis (SA) collimator lens 15a, 15b, and 15c. Emitted laser light is directed along a respective emission axis A, B, and C. In an etendue aspect ratio adjustment apparatus 40, the collimated, emitted light from illumination source 80 is directed to a first faceted array 50 that redistributes the light and redirects this light toward a second faceted array 60 for re-collimation along an output axis 70 that is defined by facets of the second faceted array 60 according to the redirected light. Facets of second faceted array 60 adjust the angular distribution of light from the first faceted array 50 to define output axis 70. The redistributed and recollimated composite light beam at the output, output beam 30, can then be directed to an optical fiber 20 or other optical system, such as using a lens 18. Using the arrangement shown for light combining apparatus 10 in FIG. 2, highly asymmetric light output from laser diodes can thus be redistributed for use with a more spherically symmetric optical system. First and second faceted arrays 50 and 60 are spaced apart by a propagation distance D2; it is advantageous to have this distance long enough to allow suitable re-combination of the redirected light beams as collimated light.

As shown in FIG. 2, first faceted array 50 has a number of array segments, 52a, 52b, and 52c that are generally linear in arrangement. Segment 52a receives incident light from laser 12a; segment 52b receives incident light from laser 12b; segment 52c receives incident light from laser 12c. Each of these segments 52a, 52b, and 52c, in turn, contain one or more optical facet elements that redirect the light to second faceted array 60; second faceted array 60, in turn, combines the redirected light to provide a composite beam having a more symmetric aspect ratio. Faceted array 50 and its array segments 52a, 52b, and 52c are substantially coplanar. Facets of second faceted array 60 are also substantially coplanar.

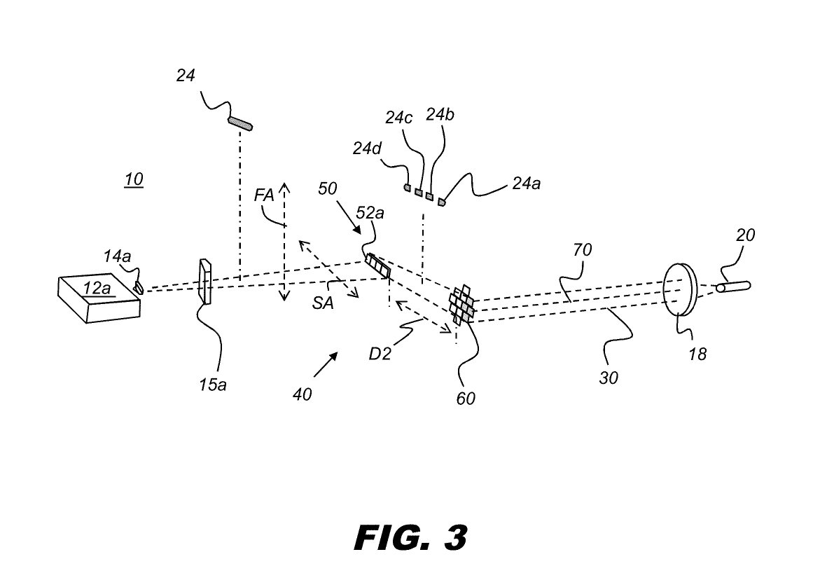

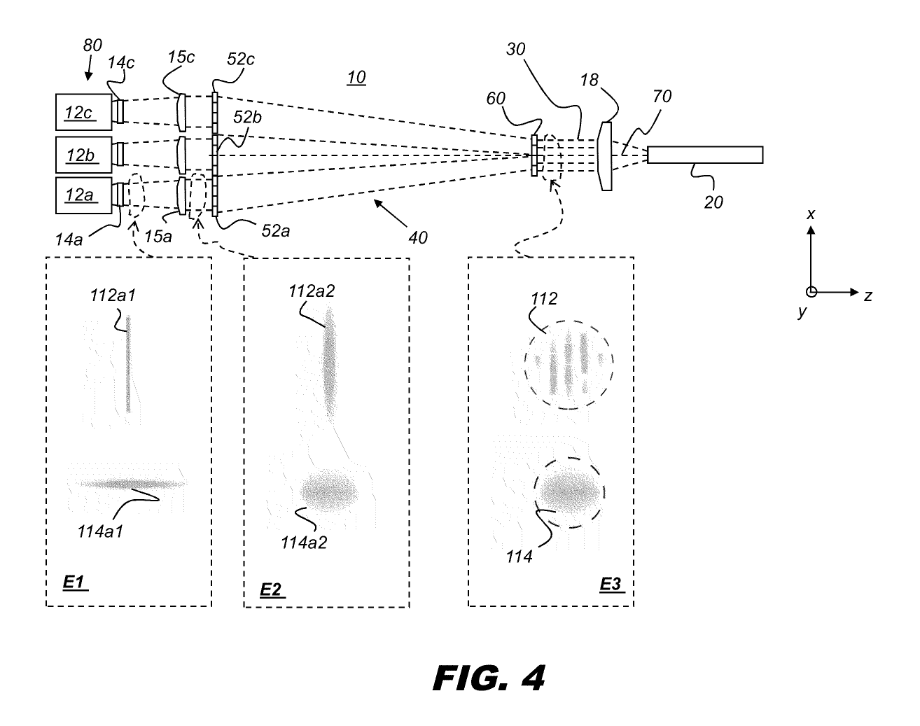

The perspective view of FIG. 3 and top plan view of FIG. 4 show the arrangement of components that are used to scale the aspect ratio of the etendue as part of etendue aspect ratio adjustment apparatus 40 in light combining apparatus 10. Each solid-state laser 12a, 12b, and 12c in illumination source 80 is energizable to emit, along an optical axis and through corresponding paired cylindrical lenses 14a/15a, 14b/15b, and 14c/15c, an input laser light beam 24 that has a first aspect ratio of etendue R₁, computed as previously described. Cylindrical lenses 14a, 14b, 14c provide collimation to their respective lasers along the fast axis FA. Cylindrical lenses 15a, 15b, and 15c provide collimation along the slow axis SA, orthogonal to FA, as shown previously with reference to FIG. 1A.

FIG. 3 shows, from a rear view perspective, how the light from one laser diode 12a is redistributed according to an embodiment of the present invention. Beam 24, generated from laser 12a after fast and slow axis collimation, has the highly asymmetric aspect ratio described with reference to FIGS. 1A-1C. Facets of array segment 52a spatially rearrange the beam, segmenting the beam into a number of portions 24a, 24b, 24c, and 24d. Each portion is separately redirected toward second faceted array 60, which realigns the beams in parallel as part of an output beam 30 along output axis 70. The parallel paths of light define output axis 70 and may have some lateral offset from axis 70.

FIG. 4 shows a top view schematic of light combining apparatus 10 and shows the spatial and angular distributions for laser diode light at different positions along the optical path. The progression of spatial distributions for light from laser diode 12a is shown at distributions 112a1, 112a2 in insets E1 and E2, respectively. The composite spatial distribution 112 in inset E3 includes beams from each of laser diodes 12a, 12b, and 12c. Angular distributions 114a1 and 114a2 for laser diode 12a are shown for corresponding positions indicated along the illumination path. The composite angular distribution 114 has the contributions from each of laser diodes 12a, 12b, and 12c. The basic rotationally symmetric aperture shape of the output beam is represented in dashed outline about distributions 112 and 114.

In terms of etendue, the rearrangement provided in FIG. 4, by splitting the light into multiple portions, changes the spatial distribution of the light and enables the optical invariant of the output beam in the SA direction to be half or less than half of the optical invariant of the original emitted output beam in that direction as shown in FIG. 4. The optical invariant of output beam 30 in the orthogonal FA direction is then at least twice that of the original output beam. This changes the aspect ratio of the etendue, providing an output beam that more closely approximates a symmetric beam and allows more efficient use of light from the laser diode.

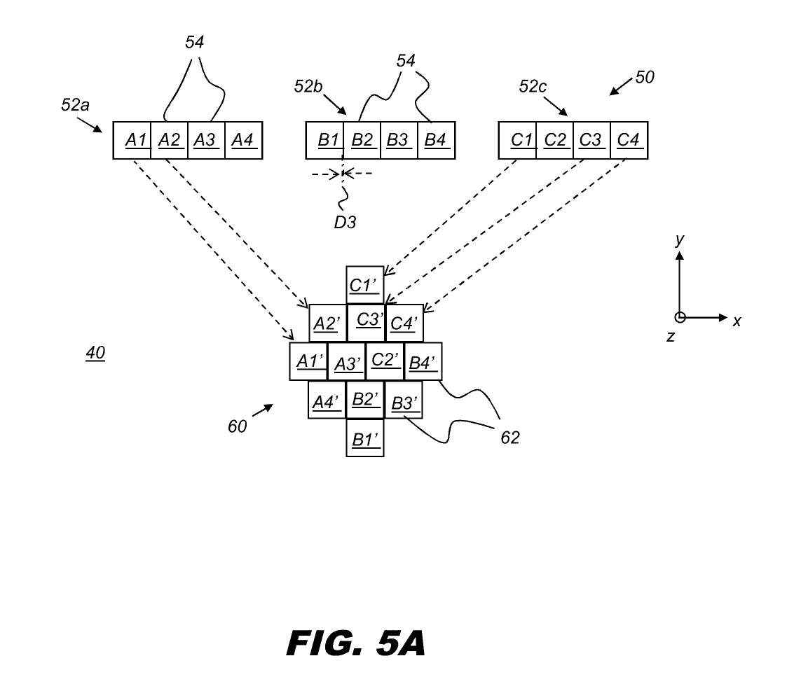

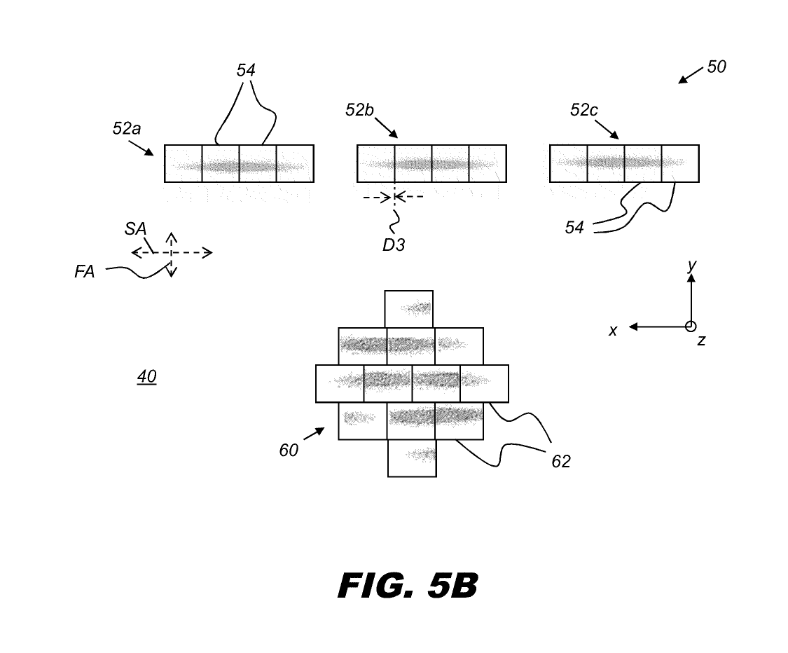

The plan views of FIGS. 5A and 5B show the mapping of light used by the redirecting facet elements from segments 52a, 52b, and 52c of first faceted array 50 to second faceted array 60. The labeling provided shows how individual light-redirecting facets 54 of first array 50 map to individual light-collimating facets 62 in second array 60 according to one embodiment of the present invention. Each facet 54, 62 is an optical element, such as a refractive optical element in the embodiment of FIG. 4; alternately, each facet could be a reflective or diffractive optical element, for example. A light-redirecting facet directs incident light to the corresponding light-collimating facet to which it is mapped. It should be noted that this mapping of facets 54 to facets 62 is a 1:1 mapping, so that light from any one particular facet on first faceted array 50 is directed to a single unique corresponding facet on second faceted array 60.

In the FIG. 5A embodiment, light-redirecting facets labeled A1, A2, A3, and A4 on the first faceted array 50 map to corresponding light-collimating facets A1′, A2′, A3′, and A4′, respectively, on second faceted array 60. Similarly, light-redirecting facets B1, B2, B3, and B4 map to light-collimating facets B1′, B2′, B3′, and B4′, respectively. Light-redirecting facets C1, C2, C3, and C4 map to light-collimating facets C1′, C2′, C3′, and C4′, respectively. It can be appreciated that this is only one of a number of possible mappings for facets between arrays 50 and 60 that can be used. FIG. 5B shows the spatial distribution of the redirected light as it is mapped to second array 60 for forming the output beam 30. As can be readily appreciated, this remapping provides an output beam for which the effective aspect ratio of the etendue (value R, calculated as described previously) more closely approximates 1.0. There is a separation distance D3 between adjacent edges of adjacent light-redirecting facets 54 of faceted array 50. This distance is less than one-sixth the propagation distance D2 between first and second faceted arrays 50 and 60 shown in FIGS. 2 and 3. Alternately stated, the light propagation distance between the first and second faceted arrays exceeds a separation distance between the first and the second light-redirecting facets by more than a factor of six. Edge-to-edge separation distance D3 is less than 1/10 of light propagation distance D2 according to an alternate embodiment of the present invention; distance D3 is less than 1/100 of distance D2 in another alternate embodiment of the present invention.

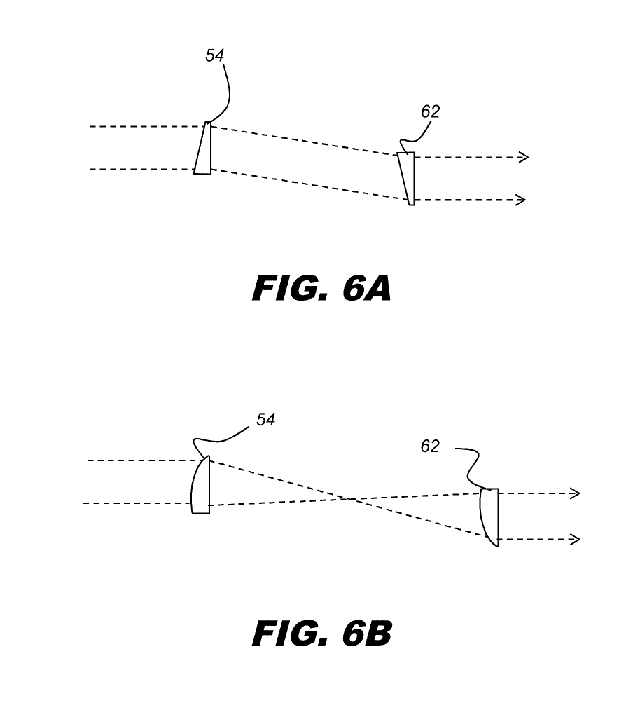

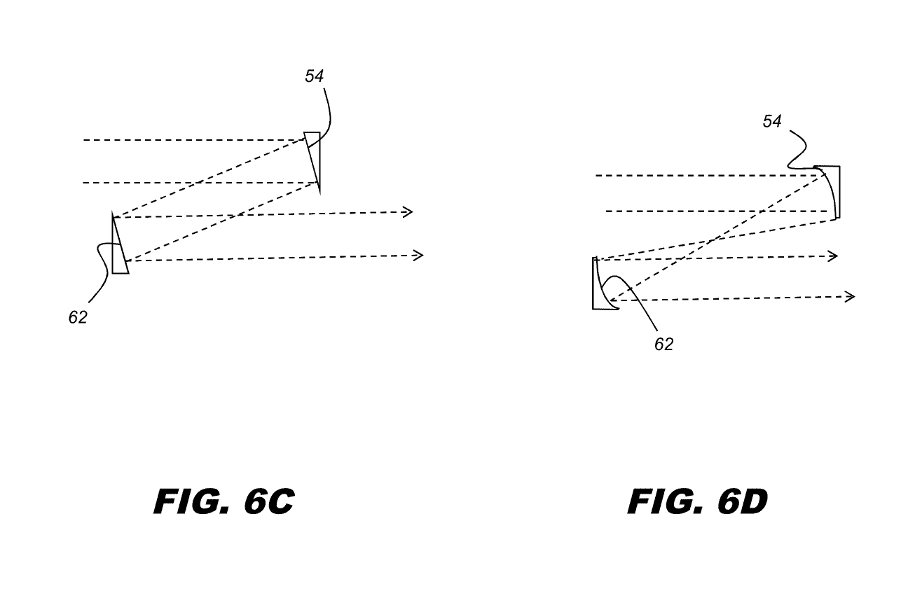

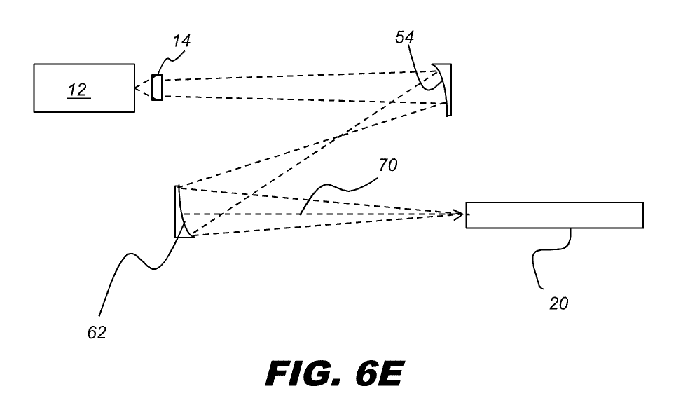

In the embodiment described with reference to FIGS. 2 through 5B, facets 54 and 62 are refractive optical elements, such as prisms, as shown in the side view of FIG. 6A. Alternately, facets 54 and 62 can have optical power, such as lenses or lens segments, as shown in the side view of FIG. 6B. In the prism embodiment of FIG. 6A, prism light-redirecting facets 54 and light-collimating facets 62 provide redirection only; the light remains substantially collimated at both faceted arrays 50 and 60 with this arrangement. The lens segments shown in FIG. 6B, on the other hand, have some optical power; the lens that serves as light-collimating facet 62 re-collimates the light to form the output beam.

The embodiments shown in FIGS. 6C, 6D, and 6E show facets 54 and 62 as reflective optical elements. In FIG. 6C, facets 54 and 62 are flat mirrors, without optical power. FIG. 6D shows an embodiment in which facets 54 and 62 are off-axis parabolic segments that redirect and re-collimate the incident light beam.

FIG. 6E shows an alternate embodiment in which reflective light-redirecting facets 54 and light-collimating facets 62 are ellipsoidal in shape and shows the optical path from laser 12 or other light source to optical fiber 20 or other optical system. Notably, this alternate arrangement can use only a fast axis collimator 14 and eliminate the need for slow axis collimator 15. In addition, the fiber focusing lens 18 can also be eliminated when optical power is provided to the facets, as shown in FIG. 6E. In such an embodiment, output axis 70 is defined by facets 62 and focused light at the input of optical fiber 20.

It should be noted that the facet arrangements shown in FIGS. 6A-6E are exemplary and that embodiments of the present invention admit any of a number of modifications to the basic patterns shown. This includes the use of hybrid designs, for example, in which facets on one array are refractive and facets on the other array are reflective. The facet shape can be aspheric or free-form. A free-form optical surface is either non-rotationally symmetric or, if symmetric, is rotated about any axis other than its axis of symmetry.

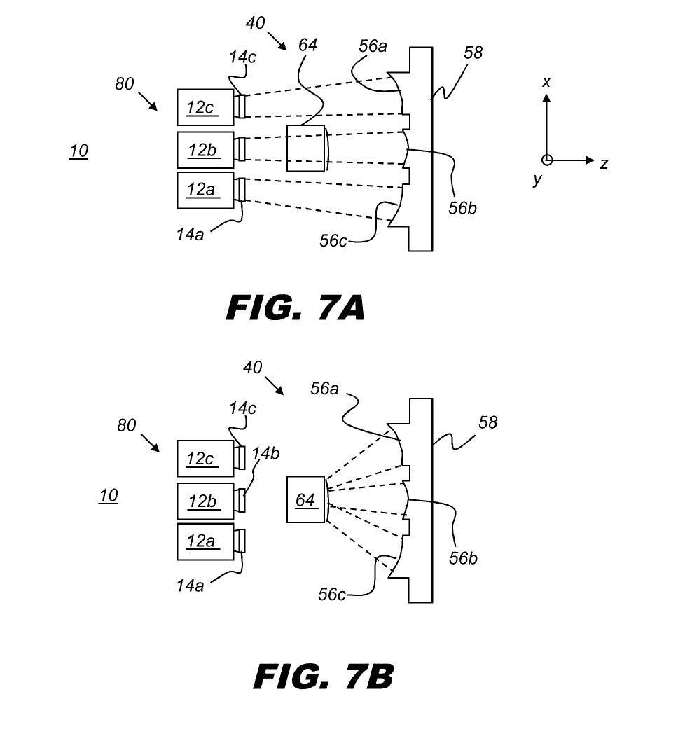

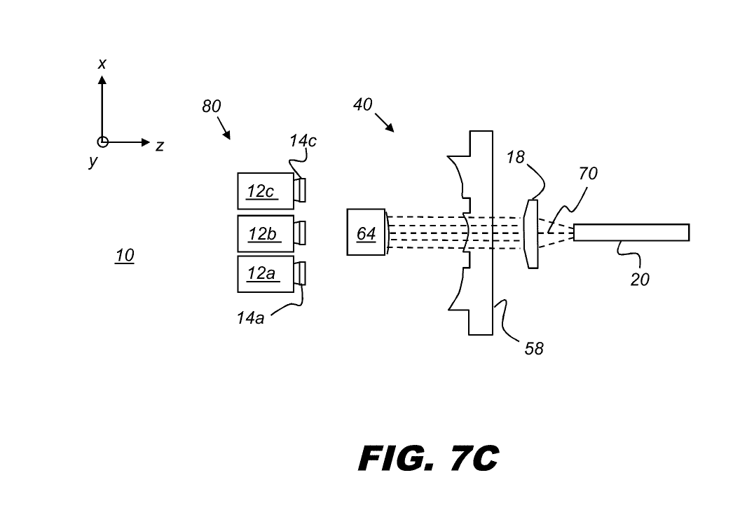

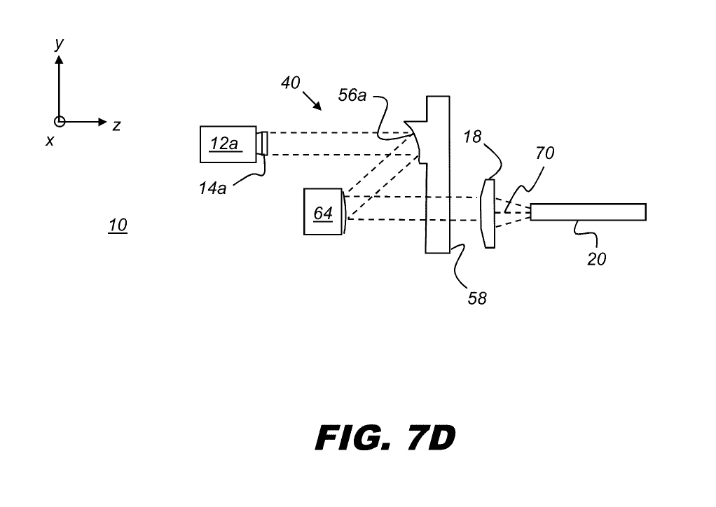

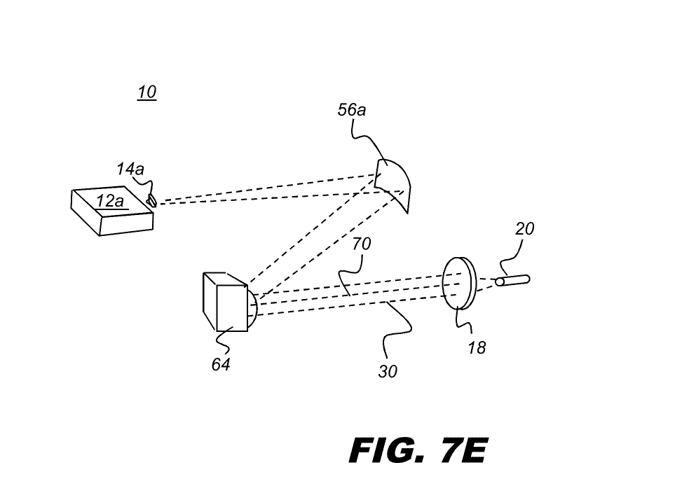

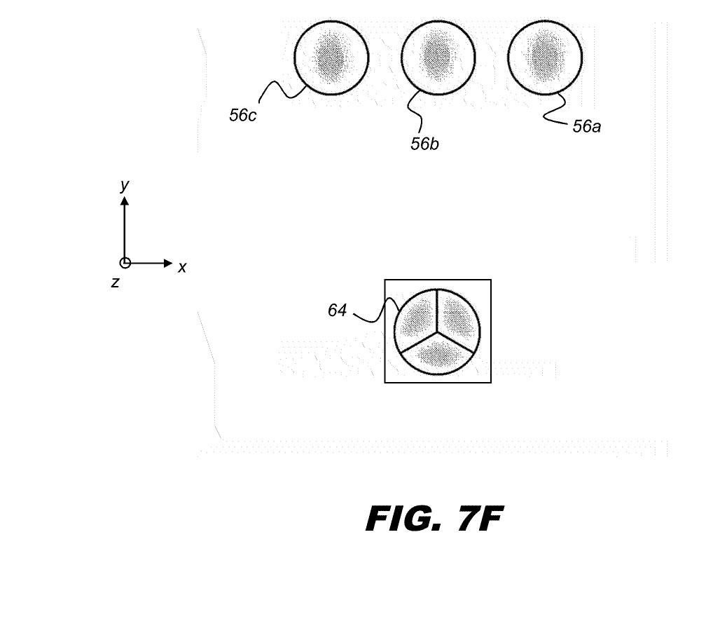

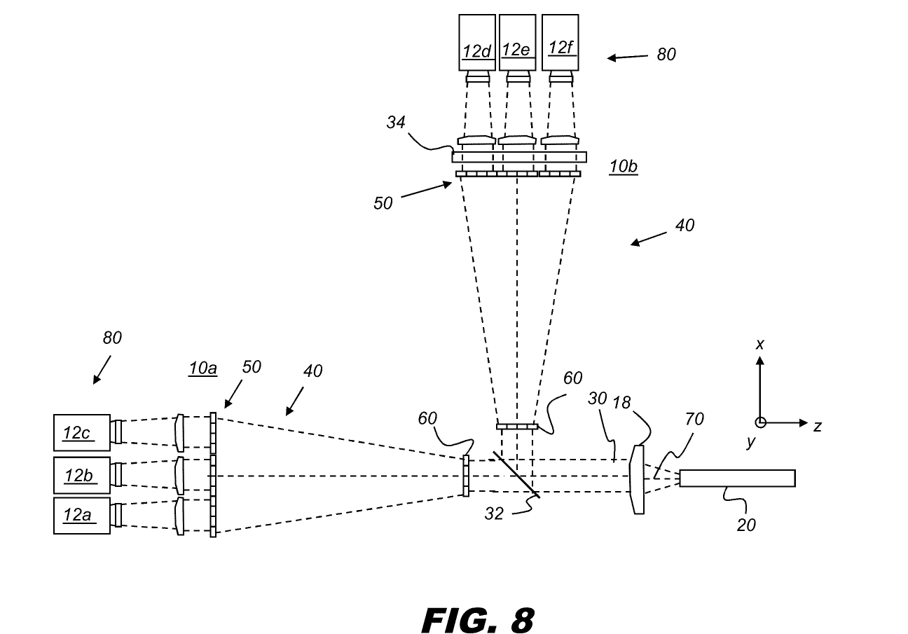

Among difficulties when using the multi-facet optical designs shown in FIGS. 2-5B is the likelihood of some amount of diffraction from edges of the individual optical elements that form each facet. Alternate embodiments of the present invention use a reduced number of facets, which helps to reduce or eliminate potential problems due to diffraction. For example, the embodiment of etendue aspect ratio adjustment apparatus 40 shown in FIGS. 7A-7F has a first faceted array 58 that has curved reflective facets 56a, 56b, and 56c, with one facet for each light channel, that is, one facet corresponding to each laser or other light source 12a, 12b, and 12c. FIG. 7A is a schematic top view showing etendue aspect ratio adjustment apparatus 40 with two faceted arrays of curved reflectors, 58 and 64. Considered from the top view of FIG. 7A, the second faceted array 64 lies below the light paths for the light incident on the first faceted array 58. FIG. 7A traces the first portion of the optical path from the laser sources to the first faceted array 58. As can be seen, the complete beam from each laser 12a, 12b, and 12c in illumination source 80 goes to a single curved facet surface. For the arrangement of aspect ratio adjustment apparatus 40 in FIG. 7A, the shaping of individual beams can be improved using free-form optical surfaces.

FIG. 7B traces that portion of the optical path as it is redirected from the first faceted array 58 to the second faceted array 64. As shown in FIG. 7C, second faceted array 64 collimates the light and directs it to lens 18 for optical fiber 20 or other system. FIG. 7D is a schematic side view showing one channel of the light combining apparatus of FIG. 7A and tracing the path of light from the laser 12a source to the pair of faceted arrays 58 and 64 and to optical fiber 20. FIG. 7E is a perspective view showing the same light channel of the light combining apparatus of FIG. 7D. Although they are slightly curved, adjacent facets, such as facets 56a and 56b, are substantially coplanar.

FIG. 7F is a plan view that shows, for a laser, LED, or other light source having a more symmetrical output beam than is typical of the laser diode, the spatial distribution of light at each of the reflective elements that are the reflective facets in the light combining apparatus of FIGS. 7A-7E. As described previously, the light in each channel is not split by first faceted array 58, but goes to a corresponding facet, thereby reducing potential diffraction along facet edges.

The approach used in the described embodiments of the present invention can be modified in a number of ways and can be used in combination with other methods for improving the etendue shape. One example of a possible combination is shown in the schematic diagram of FIG. 8. Here, a polarization beam splitter 32 combines p- and s-polarized light from light combining apparatus 10a and 10b respectively. One or more optical retarders 34 are used to change polarization of the emitted light from lasers 12d, 12e, and 12f in this embodiment. (Labels for a number of components that are repeated in FIG. 8 are omitted for improved clarity; each of the light combining apparatus 10a and 10b have the same basic set of optical components for laser light collimation and combination shown for embodiments in FIGS. 3 and 4.)

Although shown in FIG. 2 and following primarily as part of a pump module, etendue aspect ratio scaler 40 can be used to condition the laser diode output beam for input to other types of optical apparatus that work best with light that is symmetrically distributed relative to a propagation axis.

It should be noted that embodiments of the present invention can be used with a number of types of lasers in addition to laser diodes. Considering the FIG. 2 embodiment, for example, lasers 12a, 12b, and 12c of illumination source 80 can be excimer lasers or some other laser type. Other arrangements of collimating lenses 14a-14c and 15a-15c can be used where it is necessary to provide some type of initial collimation for the laser light. Array segments 52a-52c, each having two or more light-redirecting facets, would then be used to spatially redistribute portions of the emitted laser beam and to direct the redistributed portions to light-collimating facets of second facet array 60, as described previously. Advantageously, excimer laser emission can be more symmetric than laser diode emission. Embodiments of the present invention allow this more symmetric laser output to be beneficially redirected so that it can be combined to provide light that is better suited to an optically symmetric system.

Embodiments of the present invention can be particularly beneficial in applications wherein the aspect ratio of the etendue of the laser light source is asymmetric, such as when the slow axis optical invariant [symbol] ₛ exceeds the fast axis optical invariant [symbol] _{f} by at least about a factor of 2. Alternately considered, embodiments of the present invention are generally more advantageous when the optical invariant with respect to a first direction is less than half the optical invariant with respect to a second direction that is orthogonal to the first direction; this benefit tends to increase with an increase in the difference between the optical invariants in orthogonal directions. For laser pump light applications, for example, embodiments of the present invention can be advantageous where the optical invariant of the input laser light beam with respect to the FA direction can be less than ½, ⅓, ¼, or even less than one tenth of the optical invariant of the input laser light beam with respect to the SA direction. Using etendue aspect ratio adjustment apparatus 40 of embodiments of the present invention, the optical invariant of the output beam 30 with respect to the fast axis direction is more than half the optical invariant with respect to the second, slow axis direction and can be typically at least about twice the optical invariant of the emitted input laser light beam with respect to the fast axis direction. Embodiments of the present invention can be particularly useful for providing light where the optical invariant of the solid-state laser beam with respect to the SA direction exceeds the optical invariant of the optical fiber in that direction. These embodiments of the present invention are also advantageous where multiple light sources are used.

As noted previously, lasers having extended emitter stripe width have been developed, but are of limited commercial value for use with optical fiber because of excessively high asymmetry of the output beam. For such lasers, it can be advantageous to segment the emitted laser beam into even more than two, three, or four portions, extending the sequence described previously with respect to FIGS. 2-5B.

While the specific embodiments shown combine three laser diodes or other light sources to form illumination source 80, it can be appreciated that the methods and apparatus of the present invention can be used for combining any number of laser diode or other light sources, from a single laser light source, to two, three, four, or more light sources. As shown in the example of FIG. 8, various techniques can be used for combining light along multiple channels to further reduce the aspect ratio of the etendue in various embodiments.

In addition to shaping laser light from laser diodes, embodiments of the present invention can also be used to shape the etendue of combined light from multiple solid-state light sources of other types, such as from multiple LEDs. The basic arrangement of first and second arrays 50 and 60 shown schematically in FIGS. 2, 4, and 7A-7C can be used with LEDs forming illumination source 80. Suitable collimating lenses 14a-14c or other collimating optics are used with embodiments using LED sources.

Fabrication

Faceted optical arrays can be fabricated in any of a number of ways, including diamond-turning, casting, molding, or other methods. Advantageously, the set of arrays can be fabricated on a single substrate, eliminating alignment problems and reducing problems that can occur due to thermal effects. Various types of materials and coatings, such as multilayer thin film coatings, can be used for forming the array optics, depending on the type of optical element used as the facets. Arrays could be lithographically formed on a wafer.

According to an embodiment of the present invention, each faceted array is formed as a unitary component, such as a molded or machined component formed on a single block of material. This can allow reduced cost and eliminate the need for alignment. Alternately, a faceted array can be an assembled component.

The faceted optical array provides an optically discontinuous surface. That is, adjacent facets are bounded and separated by a feature that is optically discontinuous, such as along a line, fold, crease, or gap, for example. Optical discontinuity corresponds to a geometrical or mathematical discontinuity, wherein adjacent parts may be joined along a boundary but the slope of a surface changes abruptly at the boundary. In general, to reduce unwanted diffraction along the boundaries between facets, it can be advantageous to limit the number of facets for both light redirection and collimation.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. The invention is defined by the claims.

Thus, what is provided is an apparatus and method for allowing adjustment of the aspect ratio of the etendue of one or more light beams.

1. An apparatus for directing laser light comprising:
a) an illumination source having one or more lasers that are each energizable to emit laser light;
b) a first faceted array in the path of the emitted laser light from the illumination source, the first faceted array having at least a first light-redirecting facet and an adjacent second light-redirecting facet;
and
c) a second faceted array, spaced apart from the first faceted array by a light propagation distance and having at least a first light-collimating facet and a second light-collimating facet, wherein the first and second collimating facets define an output axis and wherein the emitted light that is redirected from the first light-redirecting facet is incident to the first light-collimating facet and directed along the output axis and wherein the emitted light that is redirected from the second light-redirecting facet is incident to the second light-collimating facet and directed along the output axis.

2. The apparatus of claim 1 wherein the light propagation distance between the first and second faceted arrays exceeds a separation distance between the first and the second light-redirecting facets by more than a factor of six.

3. The apparatus of claim 1 wherein the first and second light-redirecting facets are substantially coplanar with respect to a plane that is orthogonal to emitted light from the one or more lasers.

4. The apparatus of claim 1 wherein the first faceted array is formed as a single unitary component.

5. The apparatus of claim 1 wherein the illumination source comprises an excimer laser.

6. The apparatus of claim 1 wherein the illumination source comprises at least one solid-state laser.

7. The apparatus of claim 1 wherein one or more of the light-redirecting facets is refractive.

8. The apparatus of claim 1 wherein one or more of the light-redirecting facets is reflective.

9. The apparatus of claim 1 wherein one or more of the light-redirecting facets has optical power.

10. The apparatus of claim 1 wherein one or more of the light-redirecting facets presents a flat surface to the incident light from the illumination source.

11. The apparatus of claim 1 wherein one or more of the light-redirecting facets has a thin film coating.

12. The apparatus of claim 1 wherein one or more of the light-redirecting facets is a free-form optical component.

13. An apparatus for providing a light beam comprising:
a) at least one solid-state laser that is energizable to emit, along an emission axis, an input laser light beam, wherein the optical invariant of the input laser light beam with respect to a first direction is less than half the optical invariant of the input laser light beam with respect to a second direction that is orthogonal to the first direction;
b) a first cylindrical lens that is disposed to collimate the input laser light beam with respect to the first direction;
c) a first faceted array having a plurality of light-redirecting facets, with one or more of the light-redirecting facets in the path of the emitted input laser light beam and disposed to redirect at least a portion of the laser light beam from the at least one solid-state laser toward a second faceted array that is spaced apart from the first faceted array by a light propagation distance;
and
d) the second faceted array having a plurality of light-collimating facets that define an output axis for directing the redirected laser light along the output axis.

14. The apparatus of claim 13 further comprising a second cylindrical lens that is disposed to collimate the input laser light beam with respect to the second direction.

15. The apparatus of claim 13 wherein the optical invariant of the redirected laser light along the output axis with respect to the first direction is more than half the optical invariant with respect to the second direction.

16. The apparatus of claim 13 wherein the optical invariant of the input laser light beam with respect to the first direction is less than one fourth of the optical invariant of the input laser light beam with respect to the second direction.

17. The apparatus of claim 13 further comprising a rotationally symmetric lens disposed to direct the light along the output axis toward an optical fiber.

18. The apparatus of claim 17 wherein the optical invariant of the solid-state laser beam with respect to the second direction exceeds the optical invariant of the optical fiber with respect to any direction.

19. The apparatus of claim 13 further comprising a polarization beam splitter disposed along the output axis for combining light of orthogonal polarization states.

20. An apparatus for combining light comprising:
a) an illumination source having a plurality of solid-state light sources, wherein each light source is energizable to emit light;
b) at least one collimating optical element in the path of light from each of the solid-state light sources;
c) a first faceted array in the path of the emitted, collimated light from the illumination source, the first faceted array having at least a first light-redirecting facet and an adjacent second light-redirecting facet;
and
d) a second faceted array, spaced apart from the first faceted array by a light propagation distance and having at least a first light-collimating facet and a second light-collimating facet, wherein the first and second light-collimating facets define an output axis and wherein the emitted light that is redirected from the first light-redirecting facet is incident to the first light-collimating facet and directed along the output axis and wherein the emitted light that is redirected from the second light-redirecting facet is incident to the second light-collimating facet and directed along the output axis,
and wherein the light propagation distance between the first and second faceted arrays exceeds a distance between adjacent edges of the first and the second light-redirecting facets by more than a factor of six.
